(19) United States
(12) Patent Application Publication
(10) Pub. No.: US 2005/0063743 A1
(43) Pub. Date: Mar. 24, 2005

(54) Fusing apparatus for an image forming apparatus and a method thereof

(76) Inventors: Durk-hyun Cho, Suwon-si (KR); Hwan-guem Kim, Seoul (KR)

Correspondence Address: ROYLANCE, ABRAMS, BERDO & GOODMAN, L.L.P., 1300 19TH STREET, N.W., SUITE 600, WASHINGTON,, DC, 20036, US

(21) Appl. No.: 10/891,054

(22) Filed: Jul. 15, 2004

(30) Foreign Application Priority Data
Sep. 24, 2003 (KR) 2003-66169

(51) Int. Cl. G03G 15/20

(52) U.S. Cl. 399/328

(57) ABSTRACT

A fusing apparatus and method for an image forming apparatus is disclosed. The apparatus and method comprise a heating roller rotatably mounted in a support frame, a pressing roller for rotating in contact with the heating roller, and defining a predetermined nip area by contact with the heating roller, a hinge bracket mounted in the support frame, and supporting either the pressing roller or the heating roller so that either roller rotates in contact with the other roller, first and second elastic members facing each other with the hinge bracket interposed therebetween, and elastically pushing the hinge bracket respectively, and a guide member for guiding movement of the hinge bracket while supporting the respective first and second elastic members, wherein the first and the second elastic members compress and expand reciprocally.

### CROSS-REFERENCE TO RELATED APPLICATIONS

This application claims the benefit under 35 U.S.C. § 119(a) of Korean Application No. 2003-66169, filed Sep. 24, 2003, in the Korean Intellectual Property Office, the entire contents of which is incorporated herein by reference.

### BACKGROUND OF THE INVENTION

1. Field of the Invention

The present invention relates to a fusing apparatus and method. More particularly, the present invention relates to a fusing apparatus and method for an image forming apparatus, which fuses a toner image into a printing paper with predetermined temperature and pressure.

2. Description of the Related Art

A general electrophotography image forming apparatus such as a copier, and a laser printer uses an electrophotography developing method. In an electrophotography image forming apparatus, a photoconductive drum is electrified by an adjacent electrifying unit. A surface of the electrified photoconductive drum is exposed to a laser which is emitted from a laser scanning unit. Accordingly, an electrostatic latent image is formed in a pattern corresponding to a desired image. A developing apparatus supplies a toner to the photoconductive drum, and develops the electrostatic latent image on the photoconductive drum into a visible powdery toner image. When a printing paper passes between the photoconductive drum and the transfer roller which rotates in contact with the photoconductive drum, the toner image on the photoconductive drum is transferred to the printing paper. Thus, while the printing paper with the toner image transferred thereon is passing through a fusing apparatus, the toner image is fused by high temperature and pressure. The printing paper passed through the fusing apparatus is discharged.

The fusing apparatus comprises a pressing roller and a heating roller which rotate facing each other. FIG. 1 illustrates a fusing apparatus which is disclosed in Japanese Patent No. 2002-139948. Referring to FIG. 1, the fusing apparatus comprises a heating roller 12 having a heater 11, and a pressing roller 13 rotating in contact with the heating roller 12. The heating roller 12 is rotatably mounted in a support frame 10, and the pressing roller 13 is rotatably mounted in a hinge frame 14 which rotates about a hinge shaft 14a. The hinge frame 14 is pushed toward the heating roller 12 by a spring 15 such that a predetermined nip is formed between the heating roller 12 and the pressing roller 13 contacting the heating roller 12. By turning an operation lever 16 mounted in the support frame 10, the hinge frame 14 can be forcibly lowered or raised, thereby varying the compression of the spring 15. Thus, the nip between the rollers 12 and 13 can be controlled. Therefore, in case of printing on a thick paper such as an envelope, a user can lift the operation lever 16 to lower the hinge frame 14, as shown in FIG. 1. Accordingly, the nip between the rollers 12 and 13 is reduced, and the envelope is prevented from crumpling.

When using a normal printing paper having a standard thickness such as A4 paper, the user lowers the operation lever 16 to lift the hinge frame 14. Then, the nip between the rollers 12 and 13 increases.

However, using a conventional structure as described, the fusing nip between the rollers by the pressure on the rollers can be set to only two degrees. Therefore, it is inconvenient to use since papers of various thickness cannot be accommodated.

In addition, since the pressing roller is made of a silicone gum of a high coefficient of thermal expansion, or a foaming silicone gum, the shape of the pressing roller varies according to the degree of heat. Therefore, the fusing nip changes during a printing job. However, because the conventional fusing apparatus has only two modes for the fusing nip, the fusing apparatus can not adaptively cope with the various changes of the fusing nip. Further, when the pressure increases, the printing paper often crumples. In contrast, when the pressure decreases, the fusing performance is deteriorated.

### SUMMARY OF THE INVENTION

The present invention has been made to overcome the above-mentioned problems of the prior art. Accordingly, it is an aspect of the present invention to provide a fusing apparatus and method for an image forming apparatus, which has an improved structure so that a fusing nip between rollers can be maintained regularly.

In order to achieve the above-described aspects of the present invention, there is provided a fusing apparatus and method for an image forming apparatus. The apparatus and method comprise a heating roller rotatably mounted in a support frame, a pressing roller for rotating in contact with the heating roller, and defining a predetermined nip area by contact with the heating roller, a hinge bracket mounted in the support frame, and supporting either the pressing roller or the heating roller so that either roller rotates in contact with the other roller, first and second elastic members facing each other with the hinge bracket interposed therebetween, and elastically pushing the hinge bracket respectively, and a guide member guiding movement of the hinge bracket while supporting the respective first and second elastic members, wherein the first and the second elastic members compress and expand reciprocally.

One end of the hinge bracket is rotatably connected to the support frame, and the other end is movably connected to the guide member to rotatably support the pressing roller.

The hinge bracket comprises a shaft hole corresponding to a hinge shaft at one end, and a guide hole at the opposite end in which a guide member is slidably disposed.

The hinge bracket comprises an arcuate bearing part disposed between the shaft hole and the guide hole to rotatably support the pressing roller.

The pressing roller is disposed above the heating roller, and the hinge bracket is disposed above the pressing roller and rotatably supports the pressing roller in contact with the heating roller.

The first elastic member elastically pushes the hinge bracket down toward the heating roller, and the second elastic member elastically pushes the hinge bracket upward away from the heating roller.

The guide member comprises a bolt fastened to the support frame through the guide hole.

The first and the second elastic members are supported in a compressed state, while being disposed around the bolt with the guide hole positioned therebetween.

The first and the second elastic members comprise compression coil springs, and have the same elastic force.

### BRIEF DESCRIPTION OF THE DRAWINGS

These and other features, aspects, and advantages of the present invention will become better understood with regard to the following description, appended claims, and accompanying drawings where:

FIG. 1 is a diagram illustrating a conventional fusing apparatus of an image forming apparatus;

FIG. 2 is a diagram illustrating a sectional view of a fusing apparatus of an image forming apparatus according to an embodiment of the present invention;

FIG. 3 is a diagram illustrating a degree of freedom for a force operated on a hinge bracket of the fusing apparatus of FIG. 2; and

FIG. 4 is a diagram illustrating a sectional view of a pressing roller thermally expanded from a state of FIG. 2.

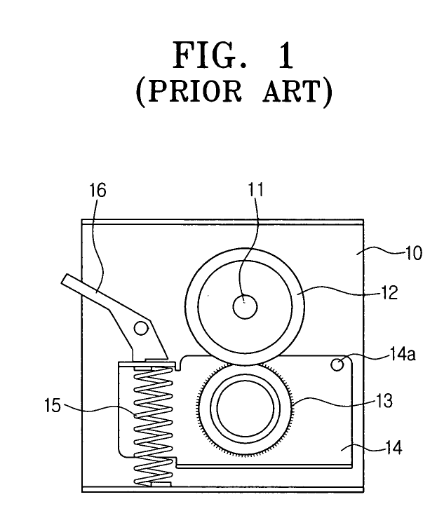

Throughout the drawings, it should be noted that the same or similar elements are denoted by like reference numerals.

### DETAILED DESCRIPTION OF THE PREFERRED EMBODIMENTS

Embodiments of a fusing apparatus for an image forming apparatus according to embodiments of the present invention will now be described in detail with reference to the accompanying drawings.

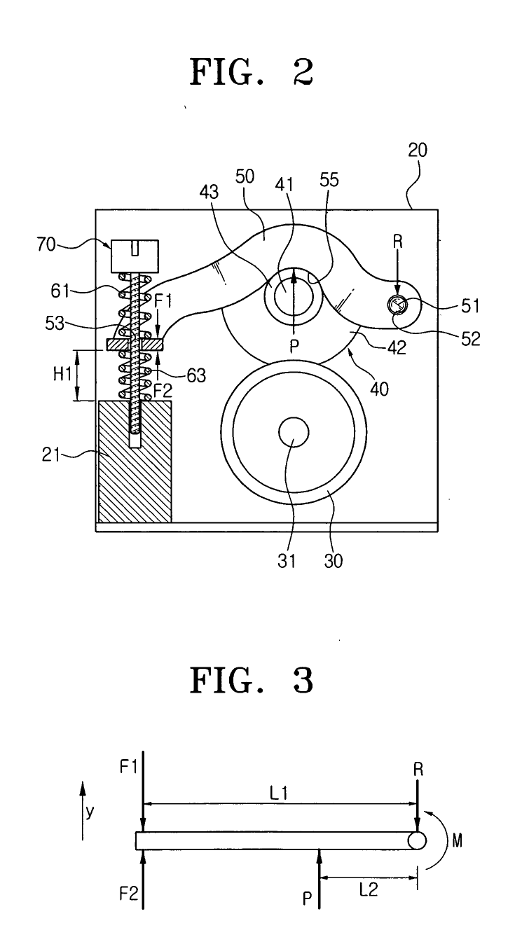

Referring to FIG. 2, a fusing apparatus of an image forming apparatus according to an embodiment of the present invention comprises a heating roller 30 rotatably mounted in a support frame 20, a pressing roller 40 rotating in contact with the heating roller 30, a hinge bracket 50 rotatably supporting the pressing roller 40, first and second elastic members 61 and 63 facing each other with the hinge bracket 50 interposed therebetween, and a guide member 70.

A heater 31 is mounted in the heating roller 30. The heating roller 30 rotates in contact with the pressing roller 40, fusing an image onto a printing paper passing between the rollers 30 and 40 using a predetermined heat and pressure.

The pressing roller 40 presses the heating roller 30 with a predetermined pressure, while rotating in contact with the heating roller 30. The pressing roller 40 has a pressing layer 42 having a predetermined thickness wrapping a shaft 41. The pressing layer 42 comprises a silicone gum or a foaming silicone gum, and can be thermally expanded by a heat caused by contact with the heating roller 30.

When the pressing roller 40 and the heating roller 30 contact each other, a fusing nip is formed between the rollers 30 and 40. Fusing time, temperature and pressure of the printing paper passing through between the rollers 30 and 40 are determined according to width of the fusing nip.

Therefore, for varying the fusing nip, the pressing roller 40 is mounted such that it can minutely move up and down on the support frame 20. One of the pressing roller 40 and the heating roller 30 is rotated by a driving motor (not shown), and the other roller is passively rotated. Preferably, the heating roller 30 is rotated by the driving motor, and the pressing roller 40 is passively rotated. In another embodiment of the present invention, the pressing roller 40 can be rotated by the driving motor, and the heating roller can be passively rotated.

The shaft 41 of the pressing roller 40A is rotatably inserted on the bearing 43. The bearing 43 is supported by the hinge bracket 50.

The hinge bracket 50 is rotatably mounted in the support frame 20 to support the pressing roller 40 so that the pressing roller 40 can rotate in contact with the heating roller 30. The hinge bracket 50 has a shaft hole 52 corresponding to a hinge shaft 51 at one end, and a guide hole 53 at the opposite end, in which the guide member 70 is slidably disposed. The hinge bracket 50 comprises an arcuate bearing part 55, which supports the bearing 43 of the pressing roller 40. The bearing part 55 is formed between the shaft hole 52 and the guide hole 53, that is, approximately in the middle of the hinge bracket 50, and supports the pressing roller 40 downward. That is, being mounted at an upper part of the pressing roller 40, the hinge bracket 50 presses the pressing roller 40 toward the heating roller 30 by its own weight.

The first and the second elastic members 61 and 63 are disposed opposite to each other with respect to the hinge bracket 50 interposed therebetween. The elastic members 61, 63 are disposed in a substantially straight line, and preferably are compression coil springs which provide an elastic pressure to the hinge bracket 50 in opposite directions. The elastic members 61 and 63 are hereinafter referred to as first and second compression springs. In an embodiment of the present invention, the first and the second compression springs 61 and 63 are disposed to provide the elastic pressure to the end of the hinge bracket 50 which is farthest side from the hinge shaft 51. The respective compression springs 61 and 63 are inserted and supported in the guide member 70. The compression springs 61 and 63 have the same elastic force. Therefore, the elastic force of the compression springs 61 and 63 operating in opposite directions with respect to the hinge bracket 50 is the same.

The guide member 70 may include a bolt which is screw-coupled with a support block 21 of the support frame 20. The bolt is engaged with the support block 21, passing through the guide hole 53 of the hinge bracket 50, and guides a vertical movement of the hinge bracket 50. The guide member 70 supports the compression springs 61 and 63 in compression. For this, a diameter of the bolt is smaller than a diameter of the guide hole 53, and also smaller than an inner diameter of the compression springs 61 and 63.

According to the above structure, the first compression spring 61 disposed around the bolt on the upper part of the hinge bracket 50 pushes the hinge bracket 50 toward the heating roller 30. The second compression spring 63 disposed around the bolt in a compressed state between the hinge bracket 50. The support block 21 elastically pushes the hinge bracket 50 upward, that is, in a direction moving away from the heating roller 30.

The load and deflection of the hinge bracket 50 by the compression springs 61 and 63 can be set up as predetermined values.

According to the above structure, when the fusing nip increases due to a thermal expansion of the pressing roller 40, a pressure P on the hinge bracket 50 increases. Then, a compressive force F1 increases as the first compression spring 61 is compressed. On the contrary, a compressive force F2 decreases as the second compression spring 63 is expanded. As a result, the pressure between the pressing roller 40 and the heating roller 30 is maintained, and the fusing nip is appropriately adjusted to a normal width. The fusing nip can be uniformly maintained because the hinge bracket 50 compensates for the expansion of the pressing roller 40 by moving upward a predetermined distance.

FIG. 3 shows a degree of freedom for a force operated on the hinge bracket of the fusing apparatus of the above structure.

According to the degree of freedom, the sum of the force acting on the hinge bracket 50 along the y-axis is zero. The sum of the rotational moment M about a rotation of the hinge bracket 50 is also zero.

More specifically, the degree of freedom of FIG. 3 can be expressed by the following equations.

Equation 1
+↑ΣFy=0; −F1+F2+P−R=0

Equation 2
+cccΣM=0; (F1−F2)×L1−P×L2=0
∴P=[(F1−F2)×L1]/L2
where, F1 is a compressive force applied on the hinge bracket 50 by the first compression spring 61, and F2 is a force applied on the hinge bracket 50 by the second compression spring 63.

P is a load transmitted to the hinge bracket 50 through the bearing of the pressing roller 40 and the fusing nip between the pressing roller 40 and the heating roller 30. R is a reaction force generated at a center of the rotation, that is, the hinge shaft 51 of the hinge bracket 50.

The forces F1 and F2 operated on the hinge bracket 50 by the first and the second compression springs 61 and 63 are calculated by Equation 3 which expresses relationship between the load applied to the springs 61 and 63 and the deflections which result.

Equation 3
δ=[(8 nD³/Gd⁴)]×P
where, δ is the compressive displacement, n is the number of turns, d is a wire diameter of a spring coil, D is a mean diameter of a spring coil, G is a shear modulus, and P is the compressive load[N(kgf)].

In the above structure, as the number of printing paper increases, the pressing roller 40 is thermally expanded by a high temperature. At this time, if the hinge bracket 50 is fixed in position, the pressure P would increase, subsequently increasing the fusing nip. If a thick paper such as an envelope is passed, the paper would crumple more often.

The embodiments of the present invention resolve the problem mentioned above. Since the hinge bracket 50 is not fixed, but is rotatable about the hinge shaft 51, when the compressive load[N(kgf)] P is changed, the hinge bracket 50 moves by the reciprocal compression and expansion of the first and the second compression springs 61 and 63. Accordingly, the fusing nip can be maintained.

In other words, if the pressure P becomes P+ΔP, the compressive force F1 of the first compression spring 61 changes to F1+ΔF1, and the compressive force F2 of the second compression spring 63 changes to F2-ΔF2.

Specifically, if P=6 kgf, F1=5 kgf, L1=40 mm, and L2=20 mm before the pressing roller 40 expands, for instance, the fusing nip is 8 mm.

After the pressing roller 40 expands, the above values change to P=8 kgf, F1=5.5 kgf, and F2=1.5 kgf. Accordingly, the fusing nip is maintained as 8 mm.

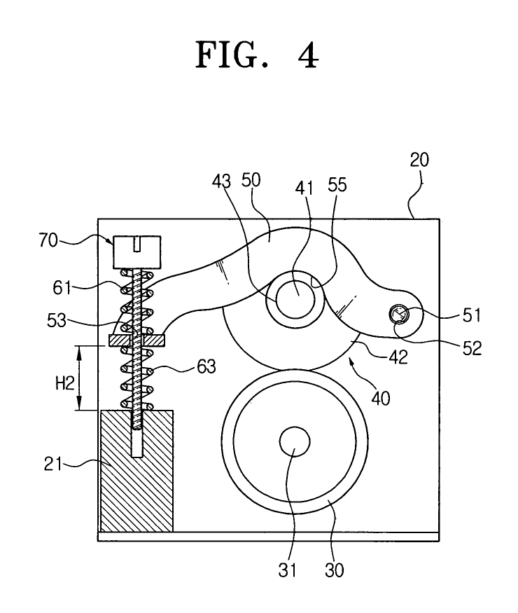

FIG. 2 shows the pressing roller 40 before the thermal expansion. A height of the second spring 63, that is, a height H1 between the hinge bracket 50 and the support block 21 increases to H2 after the pressing roller 40 expands as shown in FIG. 4 because the compressive force F1 increases as the pressure P increases, and therefore, the hinge bracket 50 is lifted as the second compression spring 63 expands such that the compressive force F2 of the second spring 63 accordingly decreases. That is, since the hinge bracket 50 is lifted as much as the expansion of the pressing roller 40, the fusing nip between the rollers 30 and 40 can be maintained.

In contrast, when the pressing roller 40 is cooled and contracted, the pressure P decreases, and the compressive force F1 of the first compression spring 61 decreases, while the compressive force F2 of the second compression spring 63 increases. Thus, the fusing nip is maintained.

The fusing nip of the conventional fusing apparatus varies according to the temperature of the pressing roller 40 during the printing job. According to an embodiment of the present invention, the fusing apparatus maintains the spacing of the fusing nip by adaptively varying the fusing nip according to the reciprocal deformation of the first and the second compression springs 61 and 63.

Meanwhile, although the present invention has been described above with reference to certain exemplary embodiments where the pressing roller 40 is disposed above the heating roller 30. The embodiments are shown by way of example, and therefore, the positions of the rollers can be adequately changed to obtain better efficiency.

With the fusing apparatus of the image forming apparatus according to the embodiments of the present invention, the spacing of the fusing nip can be maintained because the compressive force of the first and the second compression springs varies adaptively.

Therefore, even when relatively thick paper such as an envelope is used as the printing paper, crumples on the printing paper can be prevented, and a high-quality printed image can be guaranteed.

In addition, the fusing apparatus is able to handle printing papers of various thicknesses, by maintaining the fusing nip.

While the invention has been shown and described with reference to certain embodiments thereof, it should be understood by those skilled in the art that various changes in form and details may be made therein without departing from the spirit and scope of the invention as defined by the appended claims.

1. A fusing apparatus for an image forming apparatus, comprising:
a heating roller rotatably mounted in a support frame;
a pressing roller for rotating in contact with the heating roller, and defining a predetermined nip area by contacting with the heating roller;
a hinge bracket mounted in the support frame, and supporting either the pressing roller or the heating roller so that either roller rotates in contact with the other roller;
first and second elastic members facing each other with the hinge bracket interposed therebetween, and elastically pushing the hinge bracket respectively; and
a guide member for guiding movement of the hinge bracket while supporting the respective first and second elastic members,
wherein the first and the second elastic members compress and expand reciprocally.

2. The fusing apparatus of claim 1, wherein one end of the hinge bracket is rotatably connected to the support frame, and the other end is movably connected to the guide member to rotatably support the pressing roller.

3. The fusing apparatus of claim 2, wherein the hinge bracket comprises a shaft hole corresponding to a hinge shaft at one end, and a guide hole at the opposite end in which a guide member is slidably disposed.

4. The fusing apparatus of claim 3, wherein the hinge bracket comprises an arcuate bearing part disposed between the shaft hole and the guide hole to rotatably support the pressing roller.

5. The fusing apparatus of claim 1, wherein the pressing roller is disposed above the heating roller, and the hinge bracket is disposed above the pressing roller and rotatably supports the pressing roller in contact with the heating roller.

6. The fusing apparatus of claim 5, wherein the first elastic member elastically pushes the hinge bracket down toward the heating roller, and the second elastic member elastically pushes the hinge bracket upward away from the heating roller.

7. The fusing apparatus of claim 4, wherein the guide member comprises a bolt fastened to the support frame through the guide hole.

8. The fusing apparatus of claim 7, wherein the first and the second elastic members are supported in a compressed state, while being disposed around the bolt with the guide hole positioned therebetween.

9. The fusing apparatus of claim 1, wherein the first and the second elastic members comprise compression coil springs.

10. The fusing apparatus of claim 1, wherein the first and the second elastic members have the same elastic force.

11. A method of fusing for an image forming apparatus, comprising:
rotably mounting a heating roller in a support frame;
rotating a pressing roller in contact with the heating roller, and defining a predetermined nip area by contacting the pressing roller with the heating roller;
mounting a hinge bracket in the support frame, and supporting either the pressing roller or the heating roller so that either roller rotates in contact with the other roller;
providing first and second elastic members facing each other with the hinge bracket interposed therebetween, and the first and second elastic members elastically pushing the hinge bracket respectively; and
guiding movement of the hinge bracket via a guide member while supporting the respective first and second elastic members,
wherein the first and the second elastic members compress and expand reciprocally.

12. The fusing method of claim 11, further comprising:
rotatably connecting a first end of the hinge bracket to the support frame; and
movably connecting a second end of the hinge bracket to the guide member to rotatably support the pressing roller.

13. The fusing method of claim 12, wherein the hinge bracket comprises a shaft hole corresponding to a hinge shaft at one end, and a guide hole at the opposite end in which a guide member is slidably disposed.

14. The fusing method of claim 13, wherein the hinge bracket comprises an arcuate bearing part disposed between the shaft hole and the guide hole to rotatably support the pressing roller.

15. The fusing method of claim 11, wherein the pressing roller is disposed above the heating roller, and the hinge bracket is disposed above the pressing roller and rotatably supports the pressing roller in contact with the heating roller.

16. The fusing method of claim 15, wherein the first elastic member elastically pushes the hinge bracket down toward the heating roller, and the second elastic member elastically pushes the hinge bracket upward away from the heating roller.

17. The fusing method of claim 14, wherein the guide member comprises a bolt fastened to the support frame through the guide hole.

18. The fusing method of claim 17, wherein the first and the second elastic members are supported in a compressed state, while being disposed around the bolt with the guide hole positioned therebetween.

19. The fusing method of claim 11, wherein the first and the second elastic members comprise compression coil springs.

20. The fusing method of claim 11, wherein the first and the second elastic members have the same elastic force.
